(19) United States
(12) Patent Application Publication
(10) Pub. No.: US 2014/0274146 A1
(43) Pub. Date: Sep. 18, 2014

(54) SERVER WITH SCHEDULE UPDATING FUNCTION

(71) Applicant: HON HAI PRECISION INDUSTRY CO., LTD., New Taipei (TW)

(72) Inventors: RAY-LUNG LIN, New Taipei (TW); YU-TAI HUNG, New Taipei (TW)

(73) Assignee: HON HAI PRECISION INDUSTRY CO., LTD., New Taipei (TW)

(21) Appl. No.: 13/944,895

(22) Filed: Jul. 18, 2013

(30) Foreign Application Priority Data
Mar. 12, 2013 (TW) 102108562

(51) Int. Cl. H04W 4/02

(52) U.S. Cl. CPC H04W 4/02
USPC 455/456.3

(57) ABSTRACT

A server includes a database storing a schedule of a portable terminal communicating with the server. The server obtains each reminder date of the schedule of the portable terminal from the database, determines the region the portable terminal is currently in, determines whether any reminder dates are rest days of the region the portable terminal is currently in, and transmits update commands to the portable terminal to update the schedule of the portable terminal when one or more reminder dates occur on a rest day of the region the portable terminal is currently in.

### BACKGROUND

1. Technical Field

The present disclosure relates to servers, and particularly to a server capable of update schedules of portable terminals connected to the server.

2. Description of Related Art

Users can set schedules on portable terminals (e.g. smart phones). When a reminder date arrives, the portable terminals generate an alert via ringtone or vibration and may display a message. However, as the portable terminals cannot automatically update the schedule when some rest days will reach, users may be improperly reminded at rest day, and may miss some important reminders.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of a server with schedule updating function, in accordance with an exemplary embodiment.

FIG. 2 is a block diagram of a schedule updating system, in accordance with an exemplary embodiment.

### DETAILED DESCRIPTION

Embodiments of the present disclosure will now be described in detail, with reference to the accompanying drawings.

Referring to FIG. 1, an embodiment of a server 100 is connected to a portable terminal 200 via a network (e.g. Internet). A database 20 of the server 100 stores a schedule of the portable terminal 200. The portable terminal 200 uploads its schedule to the server 100 via the network.

The portable terminal 200 may include a global position system (GPS) to obtain geographical information of the portable terminal 200. The geographical information of the portable terminal 200 is transmitted to the server 100. In an alternative embodiment, the server 100 can determine the geographical information of the portable terminal 200 through the IP address of the portable terminal 200. According to the IP address of the portable terminal 200, the server 100 can determine which country the portable terminal 200 is currently in.

In this embodiment, the server 100 further includes a schedule updating system 10 and a processor 30. The system 10 includes a date obtaining module 11, a region determining module 12, a rest day determining module 13, and an executing module 14. The modules of the schedule update system 10 are managed by the processor 30 to perform functions of updating the schedule of the portable terminal 200.

The date obtaining module 11 obtains each reminder date of the schedule of the portable terminal 200 from the database 20.

The region determining module 12 determines the region the portable terminal 200 is currently in according to the geographical information or according to the IP address of the portable terminal 200.

The rest day determining module 13 determines whether at least one reminder date is a rest day of the region the portable terminal 200 is currently in. The rest day determining module 13 accesses the network to query festivals/holidays of the region the portable terminal 200 is currently in, and then determines whether at least one reminder date falls on a festival or holiday date of the region the portable terminal 200 is currently in. For example, when the user of the portable terminal 200 is in America, the rest day determining module 13 accesses the network to query whether one reminder date, Jul. 2, 2013, is a rest day of America.

The executing module 14 transmits update commands to the portable terminal 200 to update the schedule when at least one reminder date is a rest day of the region the portable terminal 200 is currently in. Specifically, when one reminder date is a rest day of the region the portable terminal 100 is in, the executing module 14 cancels the scheduled reminder of the reminder date, or reschedules the reminder date to an earlier date. For example, if the user of the portable terminal 200 works in China, and one scheduled reminder is to remind the user to transfer money between accounts in a bank on the first day of each month, because the first day of May is International Labor Day, and all banks are closed that day, the executing module 14 reschedules the reminder to occur on April 26^{th}.

In an alternative embodiment, when at least one reminder date is a rest day of the region the portable terminal 200 is currently in, the executing module 14 transmits an update prompt to the portable terminal 200, to prompt the user of the portable terminal 200 to update the schedule of the portable terminal 200.

In another alternative embodiment, when at least one reminder date is a rest day of the region the portable terminal 200 is currently in, the executing module 14 transmits an update prompt to the portable terminal 200, to query the user of the portable terminal 200 whether or not the server 100 is allowed to update the schedule of the portable terminal 200. When the server 100 is allowed to update the schedule of the portable terminal 200, the executing module 14 transmits update commands to the portable terminal 200 to update the schedule of the portable terminal 200. Specifically, when one reminder date is a rest day of the region the portable terminal 100 is in, the executing module 14 cancels the scheduled reminder date, or reschedules the reminder date to an earlier date.

With such configuration, when one reminder date of the schedule of the portable terminal 200 is a rest day of the region the portable terminal 200 is currently in, the server 100 can automatically update the schedule of the portable terminal 200 or prompt the user of the portable terminal 200 to update the schedule, thus the user will not miss important reminders.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A server comprising:
a database storing a schedule of a portable terminal communicating with the server;
a processor; and
a schedule updating system comprising a plurality of modules, the processor executing the plurality of modules to perform operations of updating the schedule of the portable terminal, the operations comprising:
obtaining each reminder date of the schedule of the portable terminal from the database;
determining the region the portable terminal is currently in;
determining whether at least one reminder date is a rest day of the region the portable terminal is currently in; and
transmitting update commands to the portable terminal to update the schedule of the portable terminal when at least one reminder date is a rest day of the region the portable terminal is currently in.

2. The server as described in claim 1, wherein the operations of transmitting update commands to the portable terminal to update the schedule of the portable terminal when at least one reminder date is a rest day of the region the portable terminal is currently in comprises: canceling the scheduled reminder of one reminder date when the one reminder date is a rest day of the region the portable terminal is in.

3. The server as described in claim 1, wherein the operations of transmitting update commands to the portable terminal to update the schedule of the portable terminal when at least one reminder date is a rest day of the region the portable terminal is currently in comprises: rescheduling one reminder date to an earlier date when the one reminder date is a rest day of the region the portable terminal is in.

4. The server as described in claim 1, wherein the region the portable terminal is currently in is determined according to the geographical information received from the portable terminal.

5. The server as described in claim 1, wherein the region the portable terminal is currently in is determined according to the IP address of the portable terminal.

6. A server comprising:
a database storing a schedule of a portable terminal communicating with the server;
a processor; and
a schedule updating system comprising a plurality of modules, the processor executing the plurality of modules to perform operations of updating the schedule of the portable terminal, the operations comprising:
obtaining each reminder date of the schedule of the portable terminal from the database;
determining the region the portable terminal is currently in;
determining whether at least one reminder date is a rest day of the region the portable terminal is currently in; and
transmitting an update prompt to the portable terminal to prompt a user of the portable terminal to update the schedule of the portable terminal when at least one reminder date is a rest day of the region the portable terminal is currently in.

7. The server as described in claim 6, wherein the region the portable terminal is currently in is determined according to the geographical information received from the portable terminal.

8. The server as described in claim 6, wherein the region the portable terminal is currently in is determined according to the IP address of the portable terminal.

9. A server comprising:
a database storing a schedule of a portable terminal communicating with the server;
a processor; and
a schedule updating system comprising a plurality of modules, the processor executing the plurality of modules to perform operations of updating the schedule of the portable terminal, the operations comprising:
obtaining each reminder date of the schedule of the portable terminal from the database;
determining the region the portable terminal is currently in;
determining whether at least one reminder date is a rest day of the region the portable terminal is currently in;
transmitting an update prompt to the portable terminal to prompt a user of the portable terminal whether or not allows the server to update the schedule of the portable terminal at least one reminder date is a rest day of the region the portable terminal is currently in; and
transmitting update commands to the portable terminal to update the schedule of the portable terminal when the server is allowed to update the schedule of the portable terminal.

10. The server as described in claim 9, wherein the operations of transmitting update commands to the portable terminal to update the schedule of the portable terminal when the server is allowed to update the schedule of the portable terminal comprises: canceling the scheduled reminder of one reminder date when the one reminder date is a rest day of the region the portable terminal is in.

11. The server as described in claim 9, wherein the operations of transmitting update commands to the portable terminal to update the schedule of the portable terminal when the server is allowed to update the schedule of the portable terminal comprises: rescheduling one reminder date to an earlier date when the one reminder date is a rest day of the region the portable terminal is in.

12. The server as described in claim 9, wherein the region the portable terminal is currently in is determined according to the geographical information received from the portable terminal.

13. The server as described in claim 9, wherein the region the portable terminal is currently in is determined according to the IP address of the portable terminal.
